(19) United States
(12) Patent Application Publication
(10) Pub. No.: US 2025/0347661 A1
(43) Pub. Date: Nov. 13, 2025

(54) ULTRASONIC INSPECTION DEVICE

(71) Applicant: Hitachi Power Solutions Co., Ltd., Ibaraki (JP)

(72) Inventors: Yoshihiro SATO, Ibaraki (JP); Kaoru KITAMI, Ibaraki (JP); Shigeru OHNO, Ibaraki (JP)

(21) Appl. No.: 19/173,274

(22) Filed: Apr. 8, 2025

(30) Foreign Application Priority Data
May 9, 2024 (JP) 2024-076293

(51) Int. Cl. G01N 29/28; G01N 29/06; G01N 29/265

(52) U.S. Cl. CPC G01N 29/28; G01N 29/265; G01N 29/069; G01N 2291/0289; G01N 2291/106; G01N 2291/2697

(57) ABSTRACT

An ultrasonic inspection device is capable of preventing adhesion of foreign matter onto a structure that comes into contact with water. The ultrasonic inspection device includes: an array probe configured to probe an inspection object having an inspection surface with an ultrasonic wave; and a water supply and drainage unit configured to supply water to a space between the inspection surface and the array probe. The water supply and drainage unit is made of a conductive material. The water supply and drainage unit includes a water discharge port through which water is supplied to the space, and a static eliminator that comes into contact with the water passing through the water discharge port and has a conductivity higher than a conductivity of a cover member forming the water discharge port. The static eliminator of the water supply and drainage unit is connected to a ground wire via a connection portion.

### CROSS-REFERENCE TO RELATED APPLICATION

The present application claims the benefit of priority to Japanese Patent Application No. 2024-076293 filed on May 9, 2024, the disclosures of all of which are hereby incorporated by reference in their entireties.

### TECHNICAL FIELD

The present disclosure relates to an ultrasonic inspection device.

### Background Art

JP2015-148493A discloses “an ultrasonic inspection device including an object holding mechanism that holds an object with an inspection surface facing downward, an array probe that probes the object with an ultrasonic wave, a tank in which the array probe is immersed in a liquid that propagates the ultrasonic wave, a probe holding mechanism that holds the array probe below the inspection surface of the object so as to face the inspection surface, and a horizontal scanning unit that horizontally scans the object and/or the array probe while a liquid surface is in contact with the inspection surface of the object due to surface tension of the liquid stored in the tank”.

### SUMMARY OF INVENTION

### Technical Problem

In the technique described in JP2015-148493A, charged water may be supplied to a space between the array probe and the object. Accordingly, foreign matter may be adsorbed onto a structure (an inspection surface of an inspection object, a water supply unit, an array probe, or the like) that comes into contact with water, which may affect inspection.

An object of the disclosure is to provide an ultrasonic inspection device capable of preventing adsorption of foreign matter onto a structure that comes into contact with water.

### Solution to Problem

An ultrasonic inspection device according to the disclosure includes: an array probe configured to probe an inspection object having an inspection surface with an ultrasonic wave; and a water supply unit configured to supply water to a space between the inspection surface and the array probe. The water supply unit is connected to a ground wire.

### Advantageous Effects of Invention

According to the disclosure, an ultrasonic inspection device capable of preventing adsorption of foreign matter can be provided.

### BRIEF DESCRIPTION OF DRAWINGS

FIG. 1 is a perspective view of an ultrasonic inspection device according to the disclosure.

FIG. 2 is a perspective view of a water supply and drainage unit.

FIG. 3 is a top view of the water supply and drainage unit.

FIG. 4 is a partial cross-sectional view of the water supply and drainage unit, and is a diagram illustrating a flow of water in the water supply and drainage unit.

FIG. 5 is a partial cross-sectional view of the water supply and drainage unit, which is different from FIG. 4, and is a diagram illustrating a flow of water in the water supply and drainage unit.

FIG. 6 is an exploded perspective view of the water supply and drainage unit.

FIG. 7 is a side view of the water supply and drainage unit.

FIG. 8 is a top view of a water supply and drainage unit according to another embodiment.

FIG. 9 is a top view of a water supply and drainage unit according to still another embodiment, and is an enlarged view of a vicinity of a water discharge port.

FIG. 10 is a flowchart illustrating an inspection method including a test operation method of the ultrasonic inspection device according to the disclosure.

### DESCRIPTION OF EMBODIMENTS

Hereinafter, aspects for implementing the disclosure (referred to as embodiments) will be described with reference to the drawings. The disclosure is not limited to the following one embodiment, and different embodiments can be combined with each other or freely modified without significantly impairing the effects of the disclosure.

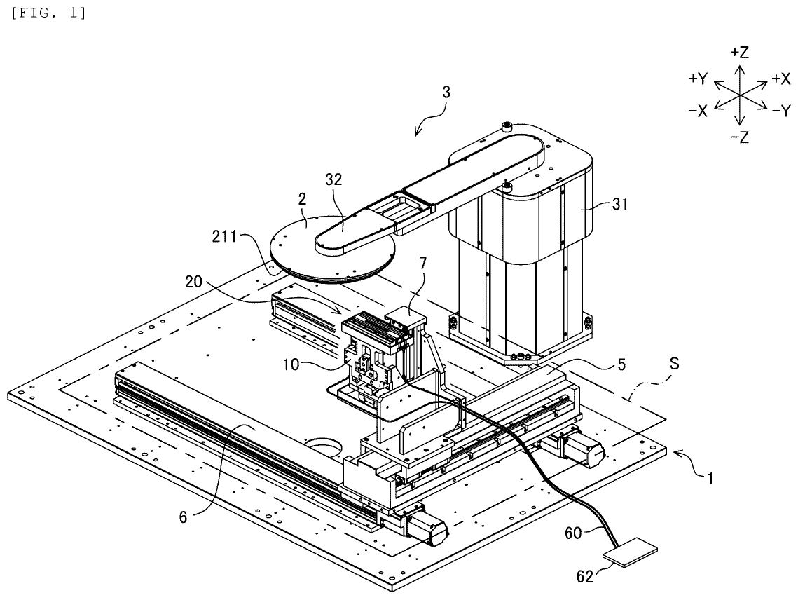

FIG. 1 is a perspective view of an ultrasonic inspection device 1 according to the disclosure. The ultrasonic inspection device 1 is a device that performs ultrasonic inspection on an inside of an inspection object 2 by irradiating the inspection object 2 with an ultrasonic wave via water (for example, pure water or ultrapure water). The inspection object 2 is, for example, a laminated body, a wafer, or the like, and in the example of the disclosure, is a structure in which a plurality of wafers (diameter 300 mm) are bonded together. The ultrasonic inspection device 1 inspects, for example, presence or absence of a bubble at an interface between a plurality of wafers.

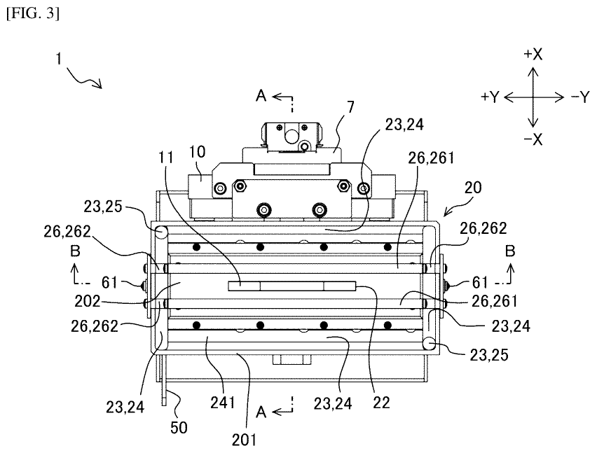

The inspection object 2 is held by a holding device 3. The holding device 3 includes a holding unit 31 and an adsorption unit 32. The holding device 3 holds the adsorption unit 32 in a horizontal direction. The adsorption unit 32 is a structure that vacuum-adsorbs an upper surface of the inspection object 2. The ultrasonic inspection device 1 includes an array probe 10. The array probe 10 irradiates an inspection surface 211 (of the inspection object 2), which is a lower surface of the inspection object 2, with an ultrasonic wave from below to above the inspection object 2. Therefore, the array probe 10 is a structure that probes, with an ultrasonic wave, the inspection object 2 with the inspection surface 211 facing downward. The array probe 10 is formed by arranging a plurality of ultrasonic elements 11 (FIG. 3) in the same horizontal direction (Y-axis direction in the illustrated example).

Note that, for the ultrasonic wave, the ultrasonic inspection device 1 may irradiate the inspection object 2 with an ultrasonic wave from above to below, with the inspection object 2 placed on a sample stage. In this case, the array probe 10 scans the inspection object 2 from above the inspection object 2.

The ultrasonic inspection device 1 includes scanning devices 5, 6, and 7 each of which is formed by an actuator, for example. The scanning device 5 is a structure that scans the array probe 10 in an X-axis direction (+X and −X directions, horizontal direction). The scanning device 6 is a structure that scans the array probe 10 in a Y-axis direction (+Y and −Y directions; horizontal direction). Therefore, the scanning device 5 and 6 scan the array probe 10 in the X-axis direction and the Y-axis direction. A scanning region S in an XY plane is defined by scanning the array probe 10 using the scanning devices 5 and 6. The scanning device 7 is a structure that moves the array probe 10 in a Z direction (+Z and −Z directions; vertical direction). The scanning devices 5, 6, and 7 are each disposed at an angle intersecting 90°.

The scanning device 5 is held by the scanning device 6 so as to be movable in the Y-axis direction by the scanning device 6. Both ends of the scanning device 5 in the X-axis direction are slidably held by two rails provided in parallel. The scanning device 7 is held by the scanning device 5 so as to be movable in the X-axis direction. The array probe 10 is held by the scanning device 7 so as to be movable in the Z-axis direction.

When performing ultrasonic inspection using the ultrasonic inspection device 1, a test operation is first performed, and then the ultrasonic inspection is performed. The test operation involves adjusting an operating condition of the ultrasonic inspection device 1 for the ultrasonic inspection, details of which will be described later. When adjusting the operating condition and performing the ultrasonic inspection, scanning is performed in the X-axis direction by moving the array probe 10. After completing scanning of one line, the array probe 10 is moved in the Y-axis direction by an arrangement length of the ultrasonic elements 11, and scanning in the X-axis direction is performed. These procedures are performed for an entire region (inspection target region) of the inspection object 2.

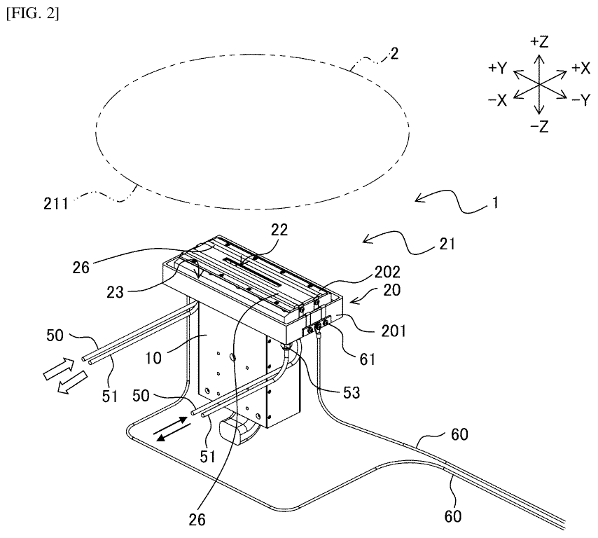

FIG. 2 is a perspective view of a water supply and drainage unit 20. In FIG. 2, for convenience of illustration, a size of a space 21 between an inspection surface 211 and the array probe 10 is illustrated to be considerably larger than an actual size. The ultrasonic inspection device 1 includes the water supply and drainage unit 20. The water supply and drainage unit 20 is disposed to cover the array probe 10. The water supply and drainage unit 20 does not cover the entire array probe 10, but covers at least the ultrasonic elements 11 (FIG. 3; a part of the array probe 10). In the illustrated example, the water supply and drainage unit 20 covers a tip end (upper end) of the array probe 10. Additionally, the water supply and drainage unit 20 is a structure that supplies water to the space 21 between the inspection surface 211 and the array probe 10 (particularly, the ultrasonic element 11), and also drains the water supplied to the space 21. As described above, the ultrasonic inspection is performed via water. Therefore, by providing the water supply and drainage unit 20, the space 21 formed between the array probe 10 and the inspection surface 211 can be filled with water, and the ultrasonic inspection can be performed via the water.

A water supply pipe 50 and a water drainage pipe 51 are connected to the water supply and drainage unit 20. The water supply pipe 50 and the water drainage pipe 51 are provided in the ultrasonic inspection device 1. The water supply pipe 50 has a function of supplying water to be supplied to the space 21 to the water supply and drainage unit 20. A water supply source (not illustrated) is connected to a side of the water supply pipe 50 opposite to a side connected to the water supply and drainage unit 20. The water drainage pipe 51 drains the water discharged from the space 21 from the water supply and drainage unit 20. A drain destination (not illustrated) is connected to a side of the water drainage pipe 51 opposite to the side connected to the water supply and drainage unit 20. By providing the water drainage pipe 51, the water discharged from the space 21 can be drained to the drain destination (not illustrated) through the water drainage pipe 51 without overflowing from the water supply and drainage unit 20. Accordingly, scattering of water below the water supply and drainage unit 20 due to the overflow from the water supply and drainage unit 20 can be prevented.

The water supply pipe 50 and the water drainage pipe 51 are, for example, a flexible tube, or a hose. A constituent material of the water supply pipe 50 and the water drainage pipe 51 is not particularly limited, and for example, a resin having physical durability and chemical durability is preferred. As such a resin, for example, a fluororesin can be used. By using the fluororesin, resin particles can be prevented from falling off from the water supply pipe 50 due to the flow of water.

Two water supply pipes 50 and two water drainage pipes 51 are connected, but only one of each may be connected. One water supply pipe 50 and one water drainage pipe 51 are connected to one end side of the water supply and drainage unit 20 having a rectangular shape when viewed from above. The other water supply pipe 50 and the other water drainage pipe 51 are connected to the other end side of the water supply and drainage unit 20 having a rectangular shape when viewed from above. The water supply pipe 50 and the water drainage pipe 51 are connected to the water supply and drainage unit 20 so as to extend downward from the water supply and drainage unit 20. Therefore, a connection port 52 (to be described later) for connecting the water supply pipe 50 to the water supply and drainage unit 20 is provided on the water supply and drainage unit 20 so as to extend in the vertical direction. A connection port 53 (to be described later) for connecting the water drainage pipe 51 to the water supply and drainage unit 20 is also provided on the water supply and drainage unit 20 so as to extend in the vertical direction.

The ultrasonic inspection device 1 includes a ground wire 60, and the water supply and drainage unit 20 (also serving as a water supply unit) is connected to the ground wire 60. For some reason, the water supply and drainage unit 20 may be supplied with charged water. Specifically, for example, this may occur when a material of the water supply pipe 50 is a material that easily charges flowing water, when water is charged in the water supply source (not illustrated) to which the water supply pipe 50 is connected, or the like.

For example, when the water supply pipe 50 is made of a fluororesin as described above, friction occurs between water and an inner wall of the water supply pipe 50, and static electricity caused by the friction can cause the fluororesin to be negatively charged and the water to be positively charged. When the charged water comes into contact with the water supply and drainage unit 20 and the inspection object 2, the electric charge (for example, a positive electric charge) may collect foreign matter, and the foreign matter (dirt, dust, and the like) may adhere thereto. In particular, when the foreign matter adheres to the inspection surface 211 of the inspection object 2, inspection accuracy of the ultrasonic inspection may decrease. Therefore, by connecting the ground wire 60 to the water supply and drainage unit 20, the electric charge of the water supplied through the water supply and drainage unit 20 can be released to an outside through the ground wire 60. Accordingly, when the water to be supplied is charged, the charge of the water can be eliminated, and adhesion of foreign matter due to the charged water can be prevented.

For example, a plurality of ground wires 60 (two in the illustrated example, but a single ground wire may also be used) are connected. One ground wire 60 is connected to one end side of the water supply and drainage unit 20. The other ground wire 60 is connected to the other end side of the water supply and drainage unit 20. The ground wire 60 is connected to the water supply and drainage unit 20 so as to extend downward from the water supply and drainage unit 20. Therefore, a connection portion 61 for connecting the ground wire 60 is provided on the water supply and drainage unit 20 so as to extend in the vertical direction. The connection portion 61 is provided on the water supply and drainage unit 20, and details thereof will be described later.

Returning to FIG. 1, the ground wire 60 is connected to a ground 62. The ground 62 is disposed outside the scanning region S. In this way, when the array probe 10 is moved, the array probe 10 can be prevented from coming into contact with the ground 62. Further, wetting of the ground 62 can be prevented. It is preferable that the ground wire 60 is in a slack state throughout the entire scanning region S where the array probe 10 moves. Accordingly, disconnection of the ground wire 60 can be prevented during scanning of the array probe 10.

The ground wire 60 preferably has flexibility. The ground wire 60 preferably has mechanical durability and chemical durability. In this way, disconnection of the ground wire 60 which is repeatedly stretched and contracted as the array probe 10 scans can be prevented.

The ground 62 is, for example, a ground plate. The ground plate is a metal plate. By using the ground plate, the ground wire 60 can be connected to the ground 62 even when there is no ground terminal nearby, and a degree of freedom in installation of the ultrasonic inspection device 1 can be improved. The ground 62 may be a ground terminal. All of the plurality of ground wires 60 are connected to the ground 62.

FIG. 3 is a top view of the water supply and drainage unit 20. In FIG. 3, the ultrasonic element 11 from which water is discharged to the outside from a water discharge port 22 is illustrated as being divided into three, but in reality, several tens to several hundreds of ultrasonic elements 11 are arranged in a row in the same direction (Y-axis direction) with almost no gaps.

The water supply and drainage unit 20 includes the water discharge port 22 and a water drainage portion 23. The water discharge port 22 is connected to the water supply pipe 50 and is an opening from which water is supplied to the space 21. The water discharge port 22 is formed in a cover member 202 (to be described later). The water drainage portion 23 is connected to the water drainage pipe 51 and is a mechanism provided at least partially around the water discharge port 22. By providing the water discharge port 22, water can be supplied to the space 21 through the water supply pipe 50 and the water discharge port 22. The water supplied to the space 21 may fall due to gravity, but by providing the water drainage portion 23, the falling water can be received by the water drainage portion 23 and can be drained to the outside of the ultrasonic inspection device 1 through the water drainage pipe 51.

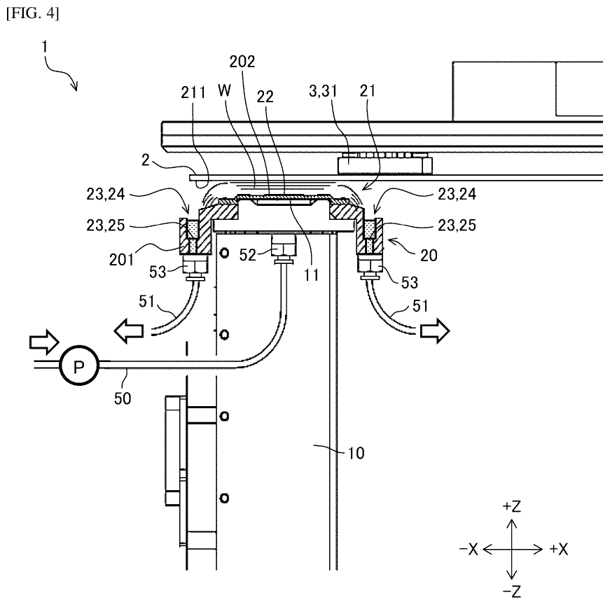

The plurality of ultrasonic elements 11 are arranged below the water discharge port 22. Therefore, an ultrasonic wave emitted from the ultrasonic element 11 reaches the inspection object 2 through the water discharge port 22. In the space 21 between the inspection object 2 and the array probe 10, particularly the ultrasonic element 11 disposed at the upper end of the array probe 10, a layer W (FIG. 4) of water discharged from the water discharge port 22 is formed. Therefore, the array probe 10 images the inspection object 2 via the layer W of water.

The water discharge port 22 has a size equal to or larger than an array portion of the plurality of the ultrasonic elements 11 forming the array probe 10. In this way, when the ultrasonic element 11 disposed below the water discharge port 22 irradiates the inspection object 2 disposed above the water discharge port 22 with the ultrasonic wave, the ultrasonic wave can be emitted through the water discharge port 22. Since the size of the water discharge port 22 is equal to or larger than the array portion of the ultrasonic elements 11, the cover member 202 forming the water discharge port 22 does not become an obstacle. Therefore, the ultrasonic wave can be applied to a target position of the inspection object 2.

In the illustrated example, a shape of the array portion of the plurality of ultrasonic elements 11 and a shape of the water discharge port 22 are both a rectangular shape when viewed from above the water supply and drainage unit 20. The water discharge port 22 has a shape slightly larger than the array portion of the ultrasonic elements 11 (when the plurality of ultrasonic elements 11 are viewed as a whole).

FIG. 4 is a partial cross-sectional view of the water supply and drainage unit 20, and is a diagram illustrating a flow of water in the water supply and drainage unit 20. FIG. 4 is a diagram of the water supply and drainage unit 20 when viewed from a side surface (Y-axis direction), and illustrates a cross section of the water supply and drainage unit 20 taken along a line A-A in FIG. 3. Hereinafter, the structure of the water supply and drainage unit 20 will be described with reference to FIG. 3.

As described above, the water discharge port 22 is connected to the water supply pipe 50. The water supply pipe 50 is provided with a pump P, and water is discharged upward from the water discharge port 22 by driving the pump P. The space 21 is formed above the water discharge port 22. Therefore, water can be supplied to the space 21 from below the inspection object 2. The pump P is preferably controlled such that an amount of water discharged per unit time through the water drainage portion 23 is larger than an amount of water supplied per unit time through the water discharge port 22. Accordingly, overflow of water from the water drainage portion 23 can be prevented.

The water drainage portion 23 is provided at least partially around the water discharge port 22. The water drainage portion 23 includes a water drainage groove 24 disposed adjacent to the water discharge port 22, and a water drainage port 25 formed in a bottom portion 241 of the water drainage groove 24. The water drainage pipe 51 is connected to the water drainage port 25. In this way, water flowing into the water drainage groove 24 can be collected in the water drainage port 25 and drained through the water drainage port 25.

In the illustrated example, the water drainage portion 23 is provided over an entire periphery of the water discharge port 22. In this way, the water discharged from the water discharge port 22 can easily flow into the water drainage portion 23. Since a length of the water drainage portion 23 that receives water can be increased, an amount of water received by the entire water drainage portion 23 can be increased. Accordingly, the overflow of water from the water drainage portion 23 can be prevented. As long as there is no problem with the drainage function, the water drainage portion 23 does not necessarily have to be disposed around the entire periphery of the water discharge port 22, and may be disposed around only a part of the water discharge port 22.

The bottom portion 241 is, for example, a bottom surface when a bottom of the water drainage groove 24 has a surface, a pointed portion when the water drainage groove 24 has a pointed lowermost end in order to narrow downward, or a side surface near the bottom surface or the pointed portion. In the illustrated example, the water drainage groove 24 has a bottom surface, and the water drainage port 25 is provided on the bottom surface of the water drainage groove 24. The bottom portion 241 may be at the same height in the horizontal direction (that is, have no slope) or may have at least one of a slope or a step descending toward the water drainage port 25.

The water drainage groove 24 is provided in a frame shape in the water supply and drainage unit 20 having, for example, a rectangular shape when viewed from above. Accordingly, the water drainage groove 24 can surround an entire periphery of the water discharge port 22, and the water drainage groove 24 can receive the water flowing from the water discharge port 22 in all directions. The water drainage port 25 is provided point symmetrically around the water discharge port 22. In the illustrated example, the water drainage port 25 is provided near two opposing corners in the frame-shaped water drainage groove 24. Accordingly, drainage through the water drainage port 25 can be promoted, water can be hardly stored in the water drainage groove 24, and the overflow of the water from the water drainage groove 24 can be prevented.

The water discharged from the water drainage groove 22 spreads and flows around the water discharge port 22 and flows into the water drainage portion 23. The water flowing into the water drainage portion 23 is drained from the water supply and drainage unit 20 through the water drainage portion 23 and the water drainage pipe 51 connected to the water drainage portion 23. Therefore, the water discharged from the water discharge port 22 to the space 21 flows toward the outside of the water supply and drainage unit 20 when viewed from the water discharge port 22, and reaches the water drainage portion 23. In this way, the layer W of water can be easily formed in the space 21 formed above the water discharge port 22.

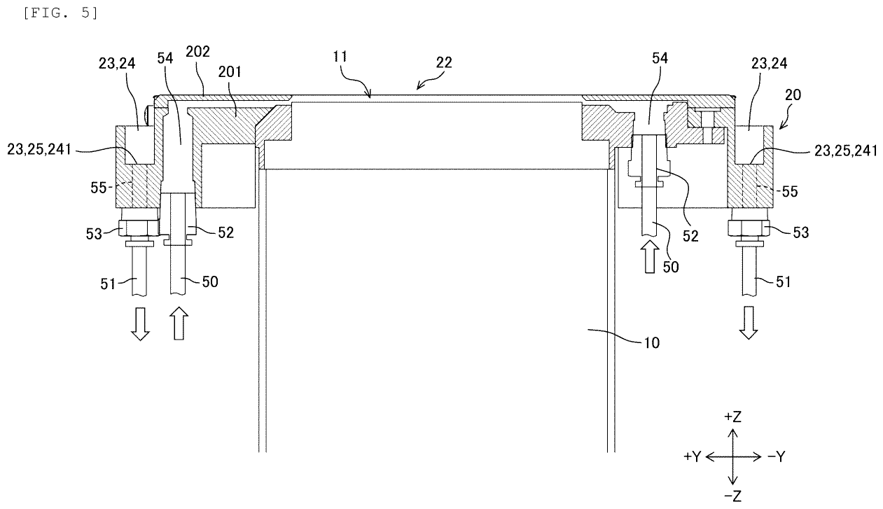

The connection port 52 to which a tip end (not illustrated) of the water supply pipe 50 is connected is disposed near the water discharge port 22. Therefore, the tip end of the water supply pipe 50 is also disposed near the water discharge port 22. Accordingly, a water conduit 54 (FIG. 5) can be shortened inside the water supply and drainage unit 20, a pressure loss in the water conduit 54 can be reduced, and water can be easily discharged from the water discharge port 22. The connection ports 52 are disposed on one end side and the other end side of the water supply and drainage unit 20. The connection port 53 to which a tip end of the water drainage pipe 51 is connected is disposed directly below the water drainage port 25 (FIG. 5).

FIG. 5 is a partial cross-sectional view of the water supply and drainage unit 20, which is different from FIG. 4, and is a diagram illustrating a flow of water in the water supply and drainage unit 20. FIG. 5 is a diagram of the water supply and drainage unit 20 when viewed from the front (X-axis direction), and illustrates a cross section of the water supply and drainage unit 20 taken along a line B-B in FIG. 3.

Inside the water supply and drainage unit 20, the connection port 52 and the water discharge port 22 are connected by the water conduit 54. Inside the water supply and drainage unit 20, the connection port 53 and the water drainage port 25 are connected by a water conduit 55. The water conduit 54 is formed between the cover member 202 and a base member 201 forming the water supply and drainage unit 20. The water conduit 54 is formed inside the base member 201 forming the water supply and drainage unit 20.

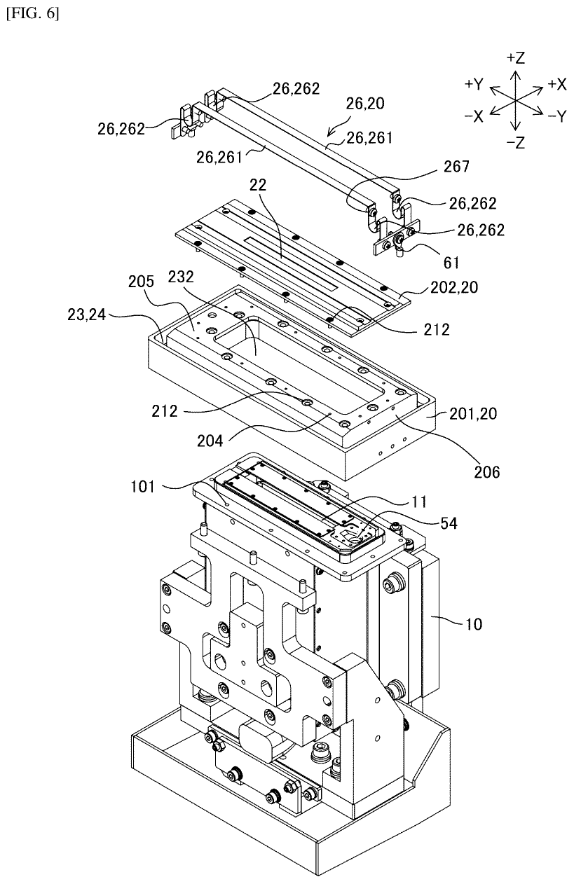

FIG. 6 is an exploded perspective view of the water supply and drainage unit 20. The water supply and drainage unit 20 includes the base member 201, the cover member 202, and a static eliminator 26.

The base member 201 is a housing of the water supply and drainage unit 20 and is a member fixed to the array probe 10. The fixing can be executed, for example, by inserting a fixing tool (not illustrated) such as a screw into a hole 212 on the base member 201 and a hole 101 provided in the upper surface of the array probe 10. Accordingly, the base member 201 is fixed to the upper end of the array probe 10.

The water drainage portion 23 is provided on the base member 201. The water drainage portion 23 is disposed continuously on four sides along an edge of the base member 201 having a rectangular shape when viewed from above. As described above, the water drainage portion 23 is a portion that receives water, and therefore, it is preferable that the water drainage portion 23 is large. Therefore, by providing the water drainage portion 23 on the base member 201 which is larger than the cover member 202, the water drainage portion 23 can be made larger, and water can be prevented from overflowing from the water drainage portion 23.

In the illustrated example, the base member 201 has a rectangular shape when viewed from above, and has a frame shape having an opening 232 at the center. When the base member 201 is fixed to the array probe 10, the ultrasonic element 11 is disposed inside the opening 203. As described above, the base member 201 has the opening 203 at a central portion, and thus has a shape in which the central portion is recessed when viewed from above. Then, the plurality of ultrasonic elements 11 forming the array probe 10 are disposed in the opening 232 which is a recessed portion. In this way, the ultrasonic element 11 can be disposed inside the base member 201, and the layer W of water can be disposed above the ultrasonic element 11. The water conduit 54 opens to a side of the ultrasonic element 11.

In the example of the disclosure, the inspection object 2 is imaged (subjected to ultrasonic inspection) by the array probe 10 disposed below the inspection object 2. However, the array probe 10 may be disposed above the inspection object 2 to image the inspection object 2 from above the inspection object 2.

The cover member 202 is a member that covers the array probe 10 and includes, for example, the slit-shaped water discharge port 22. The water discharge port 22 only needs to be large enough to allow the array portion of the ultrasonic elements 11 to be exposed to the outside above, and is not required to be as large as the water drainage portion 23. Therefore, by providing the water discharge port 22 on the cover member 202 which is smaller than the base member 201, an increase in size of the cover member 202 can be prevented.

The cover member 202 is a member disposed above the base member 201 and fixed to the base member 201. The cover member 202 is fixed to a wall portion 205 surrounding the opening 232 which is a recessed portion of the base member 201. By fixing the cover member 202 at this position, the opening 232 can be covered by the cover member 202, and water discharged from the water discharge port 22 of the cover member 202 can flow into the water drainage portion 23 disposed outside the wall portion 205 (partitioned by the wall portion 205). The fixing can be executed, for example, by inserting a fixing tool (not illustrated) such as a screw into the hole 212 on the cover member 202 and a hole 204 provided in an upper surface of the wall portion 205.

The cover member 202 is fixed such that the ultrasonic element 11 is exposed to the outside of the cover member 202 from the water discharge port 22 when viewed from above the cover member 202. In this way, the inspection object 2 disposed above the cover member 202 can be irradiated with the ultrasonic wave emitted from the ultrasonic element 11 without being blocked by the cover member 202. In particular, the inspection object 2 can be irradiated with the ultrasonic wave via the layer W of water discharged from the water discharge port 22.

The static eliminator 26 is disposed on an upper portion (upper surface) of the cover member 202. The static eliminator 26 is a member that comes into contact with water passing through the water discharge port 22 and has a conductivity higher than a conductivity of the cover member 202 (an example of a member) in which the water discharge port 22 is formed. By providing such a static eliminator 26, even when electrostatically charged water is discharged from the water discharge port 22, the static electricity can be eliminated by the static eliminator 26, and adhesion of foreign matter onto the inspection surface 211 of the inspection object can be prevented. The foreign matter may adhere to the inspection object 2, and may also adhere to the water supply and drainage unit 20, the array probe 10, and the like as long as they come into contact with water. In particular, static electricity resistance tends to decrease as the inspection object 2 such as a semiconductor product becomes smaller. Therefore, it is preferable to take a measure to eliminate static electricity using the static eliminator 26.

In the example of the disclosure, the water supply and drainage unit 20 including the base member 201, the cover member 202, and the static eliminator 26 is made of a material having an electrical conductivity (hereinafter, a conductive material). The conductive material is a material having an effect of collecting electric charges (for example, static electricity) in charged water, that is, a current collecting effect. Since the water supply and drainage unit 20 is made of a conductive material, even when charged water is supplied to the water supply and drainage unit 20, the water supply and drainage unit 20 can eliminate the electric charge from the water, and adhesion of foreign matter can be prevented.

The entire water supply and drainage unit 20 may be made of the same conductive material, or a part thereof may be made of a different conductive material. Further, materials other than the conductive material may be used in combination as long as the effects of the disclosure are not significantly impaired. Therefore, the entire water supply and drainage unit 20 does not need to be made of a conductive material, and may be made of a material that does not have a conductivity (a material generally referred to as a non-conductive material). Preferably, a portion of the water supply and drainage unit 20 with which water comes into contact is made of a conductive material. More preferably, a portion between the water drainage portion 23 and the connection port 52, which is an inlet of the water supply and drainage unit 20, is made of a conductive material.

The conductive material is preferably a non-metallic conductive material (non-metallic material) such as a conductive resin. By using the non-metallic material, the adhesion of the metallic material onto the inspection object 2 can be prevented, and the influence of the metal on the inspection object 2 can be prevented. In the example of the disclosure, a metallic material is used as a conductive material in a portion of the water supply and drainage unit 20, as will be described in detail later. However, in the portion of the water supply and drainage unit 20 that comes into contact with water, an amount of the metallic material to be used (contact area with the metal) is smaller than an amount of the conductive non-metallic material to be used (contact area with the conductive non-metallic portion). Accordingly, the contact of the metal with the inspection object 2 can be reduced, and the influence of the metallic material can be reduced.

Examples of the conductive resin include, but are not limited to, a conductive material containing carbon, and specific examples thereof include conductive MC nylon (registered trademark).

When a metallic material is used, it is preferable to use a metallic material that is resistant to corrosion, for example, a metal that is resistant to oxidation after water is dried. The metal that is resistant to corrosion is difficult to ionize in water when coming into contact with water. Therefore, the influence of metal ions on the inspection object 2 can be prevented. Examples of such a metal include stainless steel (such as SUS304), titanium, platinum, and gold. For the corrosion resistance, the conductivity can be evaluated based on a corrosion potential at a temperature (water temperature) when water is passed through the water supply and drainage unit 20 (during the test operation or the ultrasonic inspection).

Among the members forming the water supply and drainage unit 20, the base member 201 and the cover member 202 are made of a non-metallic conductive material such as a conductive resin (that is, made of a non-metallic conductive material). On the other hand, among the members forming the water supply and drainage unit 20, the static eliminator 26 is made of a metallic material and is connected to the ground wire 60. From the viewpoint of the magnitude of the current collecting effect, the metallic material has a current collecting effect greater than that of the non-metallic conductive material. Therefore, by connecting the ground wire 60 to the static eliminator 26 made of a metallic material having a large current collecting effect, the electric charge collected by the static eliminator 26 can be actively released by the ground wire 60, and the static elimination by the static eliminator 26 can be promoted.

As described above, in the water supply and drainage unit 20, an amount of the metallic material to be used is smaller than an amount of the non-metallic conductive material to be used particularly in a portion that comes into contact with water between the water discharge port 22 and the water drainage portion 23. Accordingly, the influence of the metallic material on the inspection object 2 can be reduced.

In the example of the disclosure, the static eliminator 26 is made of stainless steel (for example, SUS304 which is austenitic stainless steel) among the above metallic material. Since stainless steel is resistant to corrosion, the influence of the metallic material on the inspection object 2 can be reduced by using stainless steel.

The static eliminator 26 includes a plurality of (for example, a pair of) flat portions 261 and a plurality of bent portions 262. The flat portions 261 are members disposed on the upper surface of the cover member 202, which is the same surface as the surface on which the water discharge port 22 is formed, so as to sandwich the water discharge port 22. The upper surface of the cover member 202 is a surface of the cover member 202 facing the inspection surface 211. The flat portions 261 extend linearly in a longitudinal direction of the cover member 202.

The bent portions 262 are connected to one end and the other end of the flat portion 261, respectively. The bent portion 262 has a U-shape that is bent downward. The bent portion 262 is disposed so as to be fitted into the water drainage groove 24 on the base member 201. Therefore, the bent portion 262 is disposed along a side surface and the bottom portion 241 (bottom surface) of the water drainage groove 24. The adjacent bent portions 262 are connected to the connection portion 61 to which the ground wire 60 is connected. Therefore, the pair of flat portions 261 are connected to the connection portion 61 via the bent portions 262.

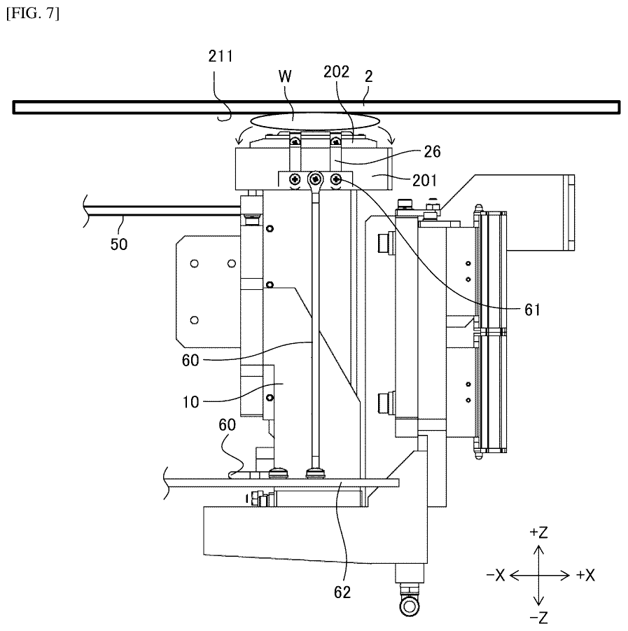

FIG. 7 is a side view of the water supply and drainage unit 20. The connection portion 61 is disposed on a side surface of the water supply and drainage unit 20, specifically, a side surface of the base member 201. The connection portion 61 is made of metal.

The ground wire 60 extends downward from the connection portion 61. Similar to the water supply pipe 50 and the water drainage pipe 51, the ground wire 60 also has flexibility and is in a slack state to some extent such that disconnection does not occur with the movement of the array probe 10.

Returning to FIG. 6, when the static eliminator 26 is further described with reference to FIG. 3, the static eliminator 26 is preferably disposed near the water discharge port 22. For example, the static eliminator 26 is provided along an edge of the water discharge port 22 in a longitudinal direction of the water discharge port 22 (provided along a direction in which the ultrasonic elements 11 are arranged at the edge of the water discharge port 22). In this way, the static eliminator 26 can be provided long, and static elimination for the water discharged from the water discharge port 22 can be quickly performed. Therefore, the effect of preventing the foreign matter adsorption by the static elimination can be enhanced. It is preferable to dispose the static eliminator 26 such that an amount of charged water that comes into contact with the inspection object 2 is as small as possible.

The static eliminator 26 is provided on both one side (+X-axis side) and the other side (−X-axis side) when viewed from the water discharge port 22. The water discharged from the water discharge port 22 generally flows to spread as described above. Therefore, by providing the static eliminator 26 at least on both one side and the other side when viewed from the water discharge port 22, the static elimination for most of the water discharged from the water discharge port 22 can be performed. In particular, when viewed in the longitudinal direction of the water discharge port 22, it is preferable that the static eliminator 26 is disposed on one side and the other side of the water discharge port 22 in a lateral direction. A relatively large amount of water flows on one side and the other side in the lateral direction when viewed in the longitudinal direction. Therefore, by locating the static eliminator 26 at this position, a static elimination effect can be enhanced.

The static eliminator 26 is disposed at least partially around the water discharge port 22. In this way, the static elimination for the water that comes into contact with the inspection object 2 can be performed.

The static eliminator 26 is provided on the upper surface of the cover member 202, which is a surface facing the inspection object 2, so that the static elimination for the water that comes into contact with the inspection object 2 can be performed.

The static eliminator 26 is fixed to at least one of the base member 201 and the cover member 202. In the illustrated example, the static eliminator 26 is fixed to the base member 201. The fixing can be performed, for example, by inserting a fixing tool (not illustrated) such as a screw into a hole 267 formed in the bent portion 262 and a hole 206 formed in a side surface (surface facing the water drainage groove 24) of the base member 201. The hole 206 can be formed by a helical insert (not illustrated) embedded in the base member 201.

A shape of the static eliminator 26 is not particularly limited, and is, for example, a band shape or a strip shape. A width (length in a lateral direction) of the static eliminator 26 is not particularly limited, and is, for example, 1 mm or more and 10 mm or less.

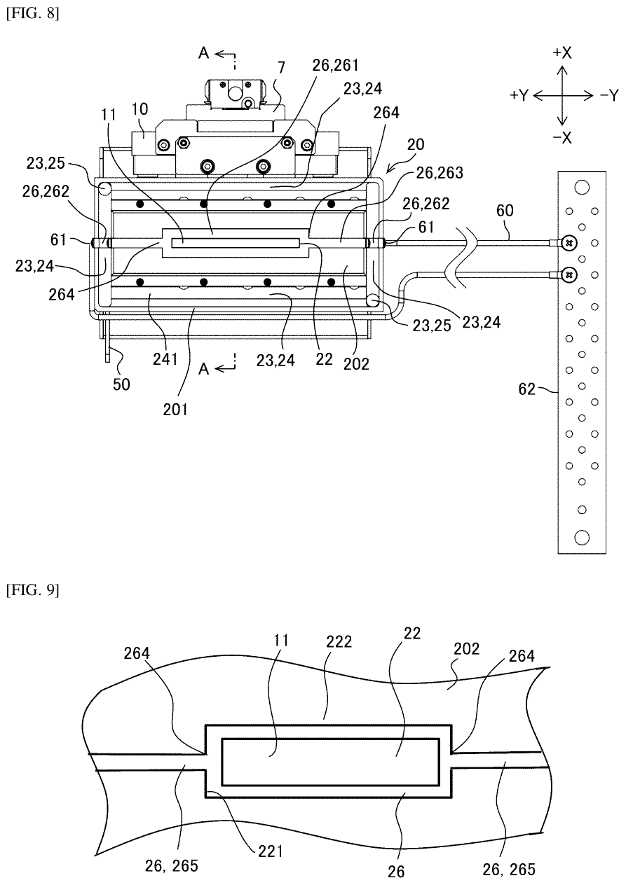

FIG. 8 is a top view of the water supply and drainage unit 20 according to another embodiment. In the embodiment in FIG. 8, a pair of flat portions 261 are also provided. In the embodiment illustrated in FIG. 3 and the like, independent bent portions 262 are connected to the pair of flat portions 261, and each of the bent portions 262 is connected to the connection portion 61. However, in the embodiment illustrated in FIG. 8, the pair of flat portions 261 are formed in a rectangular shape surrounding four sides of the water discharge port 22 having a rectangular shape. That is, the pair of flat portions 261 are connected to each other at a connection portion 264 immediately to the side of the water discharge port 22. A position of an end (edge) of the flat portion 261 on the water discharge port 22 side coincides with a position of an end (edge) of the opening forming the water discharge port 22.

Another flat portion 265 (FIG. 9) extends from the connection portion 264 between the pair of flat portions 261 toward left and right sides of the water supply and drainage unit 20. An extending direction of the flat portion 261 and an extending direction of the flat portion 265 are the same. One bent portion 262 is connected to one flat portion 265 on a side opposite to the connection portion 264. The bent portion 262 is connected to the connection portion 61.

In this way, the static elimination for the water discharged from the water discharge port 22 and spreading from the water discharge port 22 on the upper surface of the cover member 202 can be performed by the static eliminator 26. Accordingly, the static elimination can be promoted, and an amount of charged water that comes into contact with the inspection object 2 can be reduced.

FIG. 9 is a top view of the water supply and drainage unit 20 according to still another embodiment, and is an enlarged view of a vicinity of the water discharge port 22. In the embodiments described above, the static eliminator 26 is provided on the upper surface of the cover member 202. However, in the embodiment illustrated in FIG. 9, in addition to the upper surface of the cover member 202, the static eliminator 26 is further provided on an inner side wall 221 of an opening 222 forming the water discharge port 22. That is, the water discharge port 22 is partitioned by the rectangular frame-shaped static eliminator 26 made of a metallic material, and water is discharged through the rectangular frame-shaped static eliminator 26. The opening 222 is formed in the cover member 202. In this way, the water after the static elimination by the static eliminator 26 can flow out from the water discharge port 22. Accordingly, the influence of charging of water on the inspection object 2 can be particularly reduced.

A method of fixing the static eliminator 26 to the inner side wall 221 is not particularly limited. For example, the static eliminator 26 can be formed in a rectangular frame shape and fixed by being fitted into an opening (the water discharge port 22) having an inner dimension slightly smaller than an outer dimension of the static eliminator 26.

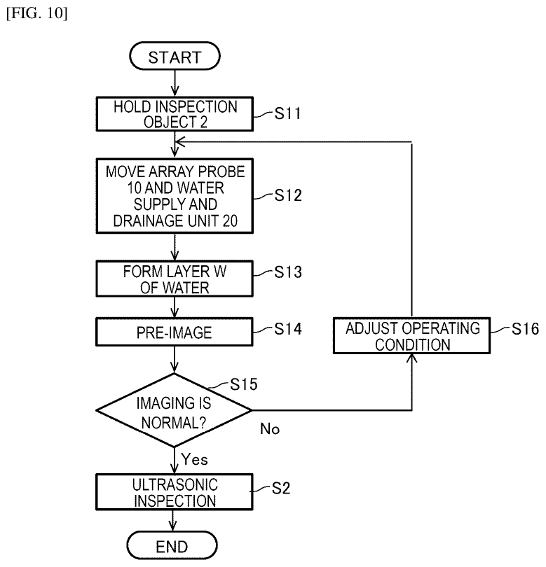

FIG. 10 is a flowchart illustrating an inspection method including a test operation method of the ultrasonic inspection device 1 according to the disclosure. The test operation method (test operation step S1) according to the disclosure is performed using the ultrasonic inspection device 1 before ultrasonic inspection (ultrasonic inspection step S2 to be described later) of the inspection object 2 by the ultrasonic inspection device 1.

When forming the layer W of water in the space 21, depending on an operating condition of the ultrasonic inspection device 1, such as a moving speed of the array probe 10, the layer W may not be formed. Even when the layer W is formed, an air bubble may be mixed in the layer W. Therefore, in order to form the uniform layer W with as little air bubbles as possible, the test operation method according to the disclosure is performed prior to the ultrasonic inspection. Then, after executing the test operation method according to the disclosure, the ultrasonic inspection device 1 is operated under an operating condition determined by the test operation method according to the disclosure, and the ultrasonic inspection step S2 is executed.

The test operation step S1 is a step of adjusting the operating condition of the ultrasonic inspection device 1 such that the layer W of water is formed in the space 21 when water is supplied to the space 21 through the water discharge port 22. By executing the test operation step S1, the uniform layer W of water with less (or no) air bubbles can be formed, and the inspection accuracy of the ultrasonic inspection can be improved.

The operating condition includes at least one condition of a distance L between the inspection object 2 and a tip end of the water supply and drainage unit 20 on the inspection object 2 side, a flow rate F per unit time of water supplied to the space 21, and a speed V at which the array probe 10 is moved with respect to the inspection object 2. These affect the state of the layer W. Therefore, by including at least one of these operating conditions, the layer W in an excellent state can be formed.

First, to explain the distance L conceptually, when the distance L is long, it becomes difficult to hold water in the space 21 by utilizing wettability of the inspection surface 211 of the inspection object 2. On the other hand, when the distance Lis too short, the water supply and drainage unit 20 is likely to come into contact with the inspection object 2. Therefore, positions of the array probe 10 and the water supply and drainage unit 20 in the Z-axis direction are adjusted such that the layer W can be formed in the space 21 and stable inspection can be performed, for example, the distance L is 0.5 mm or more and 1.5 mm or less (for example, approximately 1 mm). Specifically, the distance L can be determined by an experiment, a trial run, a simulation, or the like depending on, for example, a past operating condition, wettability of the inspection surface 211, and the like. The adjustment can be executed using the scanning device 7, for example.

Next, to explain the flow rate F conceptually, the higher the flow rate F, the greater the flow width of the water, so that the water surface is more likely to ripple, air bubbles are mixed into the layer W, and the layer W becomes unstable and not uniform. The rippling of the water surface makes it easier for the water to flow around the edge of the inspection object 2. Accordingly, in the case of the inspection object 2 in which a plurality of wafers are bonded and laminated as in the disclosure, water may enter the inside of the inspection object 2 from a bonded portion. On the other hand, the smaller the flow rate F, the smaller the flow width of the water, but when the water cannot follow the movement of the array probe 10, the layer W is torn off, and air bubbles are likely to be mixed in the water. Therefore, the flow rate F is adjusted so as not to be in these states. Specifically, the flow rate F can be determined by an experiment, a trial run, a simulation, or the like, depending on, for example, a past operating condition, wettability of the inspection surface 211, and the like. The adjustment can be performed by the pump P.

Finally, the speed V will be conceptually described. When the speed Vis too large, the array probe 10 moves before the layer W of water is formed due to the surface tension of the inspection surface 211, and the inspection is performed without the space 21 being filled with water. As a result, the inspection accuracy decreases. On the other hand, when the speed V is reduced, it takes time for the ultrasonic inspection. Therefore, the speed V is adjusted such that the space 21 can be filled with water and the ultrasonic inspection can be executed at high speed. Specifically, the speed V can be determined by an experiment, a trial run, a simulation, or the like, depending on, for example, a past operating condition, wettability of the inspection surface 211, and the like. The adjustment can be executed by controlling a drive speed of the scanning devices 5 and 6.

In the example of the disclosure, the test operation step S1 includes steps S11 to S15. In step S11 (holding step), the inspection object 2 is adsorbed by the adsorption unit 32, and the inspection object 2 is held by the holding device 3. In step S11, the inspection object 2 may be placed on a sample stage. Next, in step S12 (moving step), an integrated assembly of the array probe 10 and the water supply and drainage unit 20 is moved below the inspection object 2 by driving the scanning devices 5, 6, and 7. Next, in step S13 (water layer forming step), water is supplied to the space 21 through the water supply pipe 50, the water is discharged (overflowed) from the water discharge port 22, and the layer W of the water is formed between the water discharge port 22 and the inspection surface 211.

Next, in step S14 (pre-imaging step), under an initial operating condition, the integrated assembly of the array probe 10 and the water supply and drainage unit 20 is scanned while irradiating the inspection object 2 with an ultrasonic wave, and the inspection object 2 is imaged. Next, in step S15 (determination step), it is determined whether the imaging in step S14 is normally performed. When the determination result is normal (Yes), the ultrasonic inspection step S2 is executed using the initial operating condition. On the other hand, when there is an abnormality such as blurring of the image, the operating condition is adjusted as described above (step S16). After the adjustment, steps S12 to S15 are performed again. The adjustment is executed until it is determined to be normal in step S15.

### REFERENCE SIGNS LIST

1 ultrasonic inspection device
10 array probe
101 hole
11 ultrasonic element
2 inspection object
20 water supply and drainage unit (water supply unit)
201 base member
202 cover member
204 hole
205 wall portion
206 hole
21 space
211 inspection surface
212 hole
22 water discharge port
221 inner side wall
222 opening
23 water drainage portion
232 opening
24 water drainage groove
241 bottom portion
25 water drainage port
26 static eliminator
261 flat portion
262 bent portion
264 connection portion
265 flat portion
267 hole
3 holding device
31 holding unit
32 adsorption unit
5 scanning device
50 water supply pipe
51 water drainage pipe
52 connection port
53 connection port
54 water conduit
55 water conduit
6 scanning device
60 ground wire
61 connection portion
62 ground
7 scanning device
P pump
S scanning region
W water layer

1. An ultrasonic inspection device comprising:
an array probe configured to probe an inspection object having an inspection surface with an ultrasonic wave; and
a water supply unit configured to supply water to a space between the inspection surface and the array probe, wherein
the water supply unit is connected to a ground wire.

2. The ultrasonic inspection device according to claim 1, wherein
the water supply unit is made of a conductive material.

3. The ultrasonic inspection device according to claim 1, wherein
the water supply unit includes
a water discharge port through which water is supplied to the space, and
a static eliminator that comes into contact with water passing through the water discharge port and has a conductivity higher than a conductivity of a member forming the water discharge port, and
the static eliminator of the water supply unit is connected to the ground wire.

4. The ultrasonic inspection device according to claim 3, wherein
the static eliminator is provided at an edge of the water discharge port.

5. The ultrasonic inspection device according to claim 4, wherein
the water discharge port has a size equal to or larger than an array portion of a plurality of ultrasonic elements forming the array probe, and
the static eliminator is provided at the edge of the water discharge port along a direction in which the ultrasonic elements are arranged.

6. The ultrasonic inspection device according to claim 3, wherein
the static eliminator is made of stainless steel.

7. The ultrasonic inspection device according to claim 1, wherein
the water supply unit includes a housing made of a non-metallic conductive material.

8. The ultrasonic inspection device according to claim 1, further comprising:
a scanning device configured to scan the array probe in an X-axis direction and a Y-axis direction, wherein
the ground wire is connected to a ground outside a scanning region in an XY plane defined by scanning the array probe by the scanning device.
